(19) United States
(12) Patent Application Publication
(10) Pub. No.: US 2010/0263121 A1
(43) Pub. Date: Oct. 21, 2010

(54) CONVERTIBLE BASSINET

(75) Inventors: John (Jason) C. Arnold, IV, Philadelphia, PA (US); Thomas J. Pollack, Atlanta, GA (US); Rachel Eirich, Collegeville, PA (US)

Correspondence Address: Lempia Braidwood Graco, One North LaSalle Street Suite 3150, Chicago, IL, 60602, US

(73) Assignee: Graco Children's Products Inc., Atlanta, GA (US)

(21) Appl. No.: 12/761,213

(22) Filed: Apr. 15, 2010

Related U.S. Application Data
(60) Provisional application No. 61/169,597, filed on Apr. 15, 2009.

(51) Int. Cl. A47D 7/00; A47D 7/01; B23P 17/04

(52) U.S. Cl. 5/98.1; 5/93.1; 29/401.1

(57) ABSTRACT

A convertible bassinet has a frame with a bottom and spaced apart sides extending from the bottom. A first chamber is attachable to the frame and has a first bottom panel and a first plurality of walls with a first minimum wall height. A second chamber is attachable to the frame and has a second bottom panel and a second plurality of walls with a second minimum wall height. The frame can be arranged in a first position resting on one of the sides and supporting the first chamber and in a second position resting on the bottom and supporting the second chamber. The second minimum wall height in one example is greater than the first minimum wall height. A first elevation of the first bottom panel is greater than a second elevation of the second bottom panel in another example.

### RELATED APPLICATION DATA

This patent is related to and claims priority benefit of U.S. provisional patent application Ser. No. 61/169,597 filed on Apr. 15, 2009 and entitled “Convertible Bassinet.” The contents of this prior filed provisional application are hereby incorporated by reference herein in their entirety.

### BACKGROUND OF THE DISCLOSURE

1. Field of the Disclosure

The present disclosure is generally directed to bassinets, and more particularly to bassinets that can be converted between at least two different arrangements.

2. Description of Related Art

Many parents have the desire to keep their newborn child sleeping in the parents' bedroom for an extended time beyond a standard three month period to which most bassinets cater. There is also medical research stating the benefits of keeping a child in the parents' room for an extended time.

Once the child reaches three months old, safety compliance standards state that the wall height of a bassinet, crib, or playard should increase from 8-10 inches for a 0-3 month old (Stage 1) child to 20 inches for a three month old and/or 15 lb. (Stage 2) child. At Stage 2, a typical child is capable of pushing up on their hands and knees. Thus, a taller wall height is required.

There are a number of existing alternatives for dealing with this Stage 1 to Stage 2 age transition. One solution is common and involves setting up a crib in the parents' bedroom to accommodate a child for both Stage 1 and Stage 2. Many cribs are cumbersome and usually have to be assembled in the parents' room, disassembled to transport the crib to a separate room or nursery, and reassembled in the new location. Further, the typical crib wall height is much taller then the 8-10 inches required for a Stage 1 child. The taller wall height can make it difficult for a parent to lift their infant from a lying or prone position directly out of the crib.

Portable playards with bassinet features are known in the art. The bassinet with 8-10 inch wall can be placed over the playard sleeping or play area for use while a child is very young. The bassinet can be removed once a child exceeds the weight and/or age limits of the bassinet so that the matured child can be placed on the lower surface of the playard surrounded by walls with a minimum height of 20 inches. The GRACO Pack'n Play with Newborn Napper utilizes a third sleep surface over the bassinet for a newborn. The Napper attaches to the bassinet to reduce the area of the sleep surface relative to the bassinet and better accommodate a newborn child.

Arms Reach makes a playard-like bassinet that has a drop down side wall. The drop down wall is primarily employed to allow for better access to the child for night time feeding. The wall unfortunately can remain down, reducing the safe containment aspect of the bassinet. Arms Reach has also made multiple products to address parent child connection at sleep time such as the co-sleeping sleep surface for the child that is located in the center of the parents' bed with minimal barriers between the parent and child. The co-sleeping surface occupies space that must be avoided by a parent using the bed simultaneously with their child. Multiple competitive products have a similar design to this described product. A Bloom Bassinet utilizes a C-shaped frame profile to overhang a parents' bed. A bassinet commercially available from Eden also has a C-shaped frame profile and accommodates child containment structures for a broader child age range.

Many cribs, playards, and bassinets have structures that make placement and/or removal of a child difficult. These cribs, playards, and bassinets frequently have tall side walls and/or a sleep surface that is close to the ground. The geometry forces a caregiver to bend over substantially to attend to the child and is ergonomically awkward when the caregiver wishes to lift the child from the sleep or play surface. Many designs that attempt to accommodate a broader age range also employ removable components attached to a frame. These components may be lost and complicate the manufacture, packaging, and assembly of the product.

### SUMMARY

In one example according to the teachings of the present invention, a convertible bassinet has a frame with a bottom and spaced apart sides extending from the bottom. A first chamber is attachable to the frame and has a first bottom panel and a first plurality of walls extending up from a perimeter of the first bottom panel and has a first minimum wall height. A second chamber is attachable to the frame and has a second bottom panel and a second plurality of walls extending up from a perimeter of the second bottom panel and has a second minimum wall height. The frame can be arranged in a first position resting on one of the sides and supporting the first chamber and can be arranged in a second position resting on the bottom and supporting the second chamber. In one example, the second minimum wall height can be greater than the first minimum wall height.

In one example, the frame can be a continuous tube having multiple bends.

In one example, the sides of the frame can be extendible to increase a height of the frame in the second position.

In one example, the first and second chambers can be formed in part by one another.

In one example, when one of the first or second chambers is attached to the frame, the other of the first and second chambers can be stowed.

In one example, the bottom of the frame can have a length between the sides and the bottom can be curved along the length.

In one example, the bottom can be curved and can include two spaced apart rocker rails along the length on which the frame can rest in the second position.

In one example, the first chamber can be cantilevered on the frame in the first position.

In one example, the frame can include two spaced apart bottom bars extending horizontally along the bottom and between the sides.

In one example, each side of the frame can include two spaced apart side bars connected at an end to a corresponding end of one of the bottom bars. The spaced apart side bars can be interconnected on each side by a cross bar.

In one example, the bottom can have a first orientation with the frame in the first position and can have a second orientation with the frame in the second position. The first and second orientations can be generally perpendicular relative to one another.

In one example, the frame can be reoriented about 90° when repositioned between the first and second positions.

In one example according to the teachings of the present invention, a convertible bassinet can be configured to rest on a support surface and includes a frame having a bottom and spaced apart sides extending up from the bottom, a first chamber attachable to the frame and having a first bottom panel, and a second chamber attachable to the frame and having a second bottom panel. The frame can be arranged in a first position resting on one of the sides and supporting the first chamber with the first bottom panel at a first elevation above the support surface. The frame can also be arranged in a second position resting on the bottom and supporting the second chamber with the second bottom panel at a second elevation above the support surface. In one example, the first elevation can be greater than the second elevation.

In one example, the first chamber can have a first plurality of walls extending up from a perimeter of the first bottom panel and can have a first minimum wall height. The second chamber can have a second bottom panel and a second plurality of walls extending up from a perimeter of the second bottom panel and can have a second minimum wall height. The second minimum wall height can be greater than the first minimum wall height.

In one example, the first chamber and the second chamber can be formed at least in part by a common section of a fabric material.

In one example, the frame can be reoriented about 90° when repositioned between the first and second positions.

In one example, the first and second chambers can be removably secured to the frame at least in part by a plurality of fabric straps.

In one example, the frame can be a continuous, bent, structure when in either of the first and second positions.

In one example, a portion of the frame can be extendable and retractable to alter a height of the frame in at least one of the first and second positions.

In one example according to the teachings of the present invention, a method of reconfiguring a bassinet from a first sleeping configuration to a second sleeping configuration includes a number of steps. A frame can be provided and have a bottom and spaced apart sides extending up from the bottom. The frame can be positioned in a first position with one of the sides resting on a support surface. A first chamber can have a first bottom panel and be secured to the frame such that the first bottom panel is suspended above the support surface. The frame can be repositioned to a second position with the bottom resting on the support surface. A second chamber can have a second bottom panel and can be secured to the frame such that the second bottom panel can be suspended above the support surface.

### BRIEF DESCRIPTION OF THE DRAWINGS

Objects, features, and advantages of the present disclosure will become apparent upon reading the following description in conjunction with the drawing figures, in which:

FIG. 1 shows a perspective view of one example of a convertible bassinet constructed in accordance with the teachings of the present invention and disposed in a Stage 1 position.

FIG. 2 shows a front elevation view of the convertible bassinet in FIG. 1.

FIG. 3 a perspective view of the convertible bassinet frame in FIG. 1 in the Stage 1 position but with the soft goods removed.

FIG. 4 shows a partial perspective view of the convertible bassinet in FIG. 1 with an elastic cross bar downwardly displaced.

FIG. 5 a perspective view of the convertible bassinet frame in FIG. 3, but in a Stage 2 position with the soft goods removed.

FIG. 6 shows a perspective view of the convertible bassinet in FIG. 1, but with the disposed in the Stage 2 position of FIG. 5 and with the soft goods deployed.

FIG. 7 shows a front elevation view of the convertible bassinet in FIG. 6.

FIG. 8 shows a partial perspective view of a soft goods attachment method for the convertible bassinet in FIGS. 1 and 6.

FIG. 9 shows a perspective view of another example of a convertible bassinet constructed in accordance with the teachings of the present invention and disposed in a Stage 1 position.

FIG. 10 shows a perspective view of the convertible bassinet in FIG. 9, but in a Stage 2 position.

FIG. 11 shows a perspective view of another example of a convertible bassinet constructed in accordance with the teachings of the present invention and disposed in Stage 1 position.

FIG. 12 shows a perspective view of the convertible bassinet in FIG. 11, but in a Stage 2 position.

FIG. 13 shows a perspective view of another example of a convertible bassinet constructed in accordance with the teachings of the present invention and disposed in a Stage 1 position.

FIG. 14 shows a perspective view of the convertible bassinet in FIG. 13, but in a Stage 2 position.

### DETAILED DESCRIPTION OF THE DISCLOSURE

The disclosure is generally directed to bassinets that can be set up in different positions or arrangements with minimal adjustments. The present disclosure provides a number of examples of convertible bassinets that employ features to provide a minimum wall height complying with existing safety standards given a child's age and/or size and yet simplify set-up and usage of the bassinet. In general, the disclosed bassinets can be disposed in a first stage (Stage 1) position with lower walls and/or an elevated bottom panel or sleeping surface suitable for newborns and younger infants and a second stage (Stage 2) position with higher walls and/or a lowered bottom panel or sleeping surface that complies with existing safety standards. In one example, the bassinets can be rearranged between the two positions or arrangements by rotating the frame and repositioning, rearranging, or replacing the soft goods on the frame.

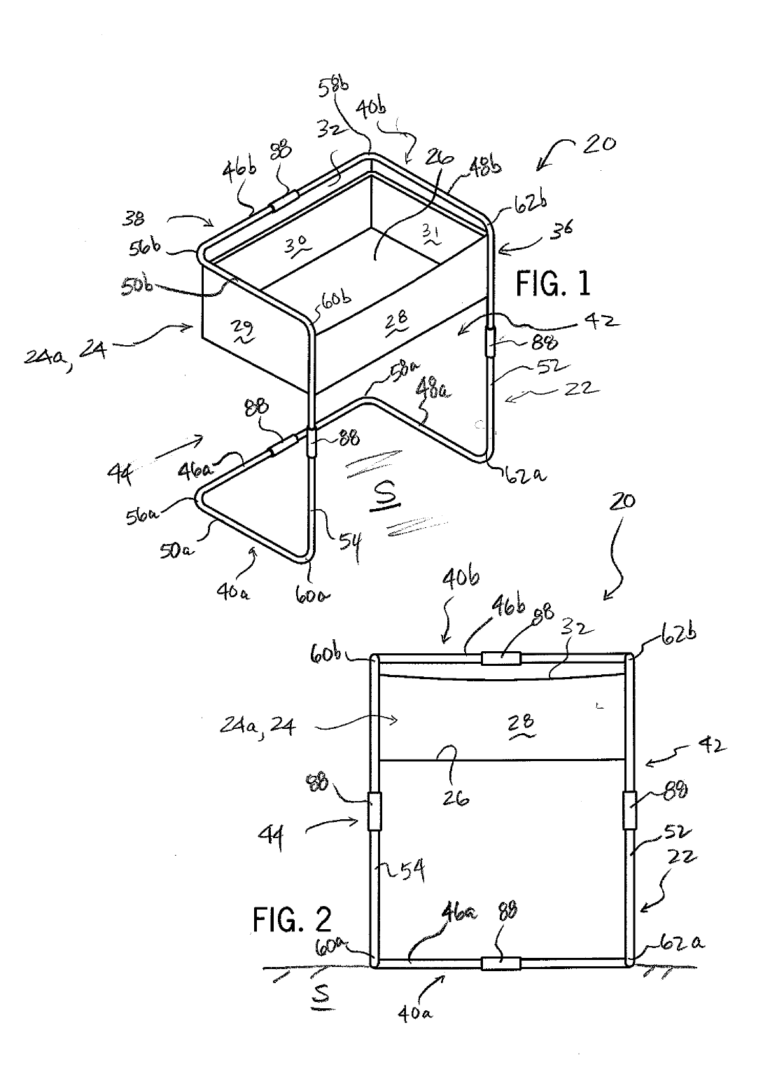

Turning now to the drawings, FIGS. 1-8 illustrate one example of a convertible bassinet 20 that is constructed in accordance with the teachings of the present invention. In this example, and with reference to FIGS. 1-3, the bassinet 20 generally includes a frame 22 and one or more sleeping chambers 24 suspended from or attached to the frame. The bassinet 20, including the frame 22 and the sleeping chambers 24, can be positioned or configured in both a Stage 1 position and a Stage 2 position as discussed herein. As shown in FIG. 1, when the bassinet 20 is in the Stage 1 position, the sleeping chamber 24 is configured as a first chamber 24a for supporting a Stage 1 infant or child. In this example, the first chamber 24a has a first bottom panel 26 surrounded by perimeter side walls 28, 29, 30, 31. The side walls 28, 29, 30, 31 each extend to and terminate at a top edge 32, which defines an open top end of the chamber 24a. In this example, the side walls 28, 29, 30, 31 have a minimum first wall height that is suitable for a 0-3 month old infant, and in one example can be 8-10 inches in height. Also in this example, the top edges 32 of one or more of the walls 28, 29, 30, 31 can be attached to the frame 22, as described in greater detail below, which in turn suspends the first bottom panel 26 above a support surface S on which the frame rests. For the Stage 1 position, the first bottom panel 26 is elevated well above the support surface S at a first elevation. The first elevation can be such that a caregiver need not bend very much to reach the infant when resting on the first bottom panel 26.

FIGS. 1, 2, and 4 show the first chamber 24a attached to the frame 22 with the frame and bassinet in the Stage 1 position. In this example, the first bottom panel 26 is generally rectangular with four edges defining the perimeter. The first bottom panel 26 is surrounded by the four side walls 28, 29, 30, 31 that extend upward from the corresponding perimeter edges of the bottom panel. As will become evident to those of ordinary skill in the art, the shape and size of the first chamber 24a can vary from the rectangular example shown and described with reference to FIGS. 1-8. Also, the side wall height can vary for each of the side walls, or each can be of the same height. In this example, the side wall 28 defines a front of the first chamber 24a and is shorter than the rear of the chamber defined by the side wall 30. Similarly, the ends of the chamber are defined by the side walls 29, 31, each being of a similar height to the rear side wall 30 in this example. Further, as shown in FIG. 4, one or more of the walls 28, 29, 30, 31, such as the front side wall 28 can have an elastic cord or band 34 (represented by the phantom line therein) along its top edge 32, if desired. Such a wall construction would allow a caregiver to easily lower the wall to better access their Stage 1 infant while resting or sleeping in the first chamber 24a, more easily place the infant in the first chamber, or more easily remove the infant from the chamber.

As shown in FIGS. 1-3 and 5, the frame 22 in one example can be formed of a continuous bent bar or tube structure. In this example, the frame 22 generally has a front 36 and a rear 38. The frame 22 also generally has two opposed sides 40, a base or bottom 42 that extends between the sides, and a top 44 that is spaced from the bottom and also extends between the sides. The front 36 and rear 38 also extend between the sides 40a, 40b. In this example, the frame 22 forms a generally rectangular, partial box configuration with the opposed sides 40a, 40b being parallel to one another, the top 44 and bottom 42 being generally parallel to one another, the front and rear 36, 38 being generally parallel to one another and generally perpendicular to the sides, top and bottom, and the sides being generally perpendicular to the top and bottom. In the Stage 1 position of FIGS. 1-3, the frame 22 is positioned with one of the sides 40a resting on the supporting surface S such as a floor. The front 36, rear 38, bottom 42, and top 44 in this position extend upward from the support surface S toward the other side 40b, which is spaced above the surface S.

As shown in FIGS. 1 and 2, the side wall top edges 32 of the first chamber 24a can be attached to the elevated side 40b of the frame 22 with the open top facing upward. The first bottom panel 26 is thus suspended from the frame 22 and spaced well above and lying parallel to the support surface S. In this example, the bent frame structure as depicted in FIG. 5 forms the pair of sides 40a, 40b with each having a front corner bar 46a, 46b that is oriented vertically. Each side 40a, 40b also has a respective bottom bar 48a, 48b and top bar 50a, 50b spaced upward from and parallel to the corresponding bottom bars. The bent frame structure also has a bottom rail 52 and a top rail 54 each extending between the frame sides 40a, 40b. The bottom rail 52 forms a part of the frame bottom 42 and the top rail 54 forms a part of the frame top 44.

The front end of each top bar 50a, 50b is joined to the top end of the respective front corner bars 46a, 46b at a top front bend 56a, 56b. The front end of each bottom bar 48a, 48b is joined to the bottom end of the respective front corner bars 46a, 46b at a bottom front bend 58a, 58b. Each of the front bends 56a, 56b and 58a, 58b is curved, lies in a generally vertical plane, and orients the corner bars 46a, 46b within a common vertical plane and at right angles relative to the top and bottom bars 50a, 50b and 48a, 48b in this example. Likewise, the rear end of each top bar 50a, 50b is joined to a respective end of the top rail 54 at a top rear bend 60a, 60b. The rear end of each bottom bar 48a, 48b, is joined to a respective end of the bottom rail 52 at a bottom rear bend 62a, 62b. Each of the rear bends 60a, 60b and 62a, 62b is curved, lies in a generally horizontal plane, and orients the bottom bars 48a, 48b and top bars 50a, 50b in a common horizontal plane and at right angles relative to the top and bottom rails 52 and 54.

In the disclosed example, the top and bottom rails 54, 52 are longer than the front corner bars 46a, 46b and are longer than the top and bottom bars 48a, 48b and 50a, 50b. Thus, the frame 22 has a width between the sides 40a, 40b in this example that is greater than a depth between the front 36 and rear 38, and greater than a height between the bottom 42 and top 44. As will be evident to those having ordinary skill in the art upon reading this disclosure, the usage of the terms front, rear, top, bottom, and side is somewhat arbitrary and can vary from the usage herein. These terms are used herein to relate various components and regions of the frame 22 and bassinet 20 to one another and for convenience of description. The actual front, rear, top, bottom, and sides of the bassinet 20 and frame 22, as well as the chamber 24, will vary depending upon the orientation or position of the bassinet during use.

In the Stage 1 position of FIGS. 1-3, the frame 22 in this example rests on the side 40a and thus on the front corner bar 46a, the bottom bar 48a, and the top bar 50a. In the Stage 1 position, the first chamber 24a is suspended from the other side 40b. In this example, the top edge 32 of the rear side wall 30 of the chamber 24a is attached to the front corner bar 46b. The front side wall 28 spans the gap between the top and bottom rear bends 60b, 62b and the top edge 32 including the cord 34 is free. The top edges 32 of the end side walls 29, 31 of the chamber 24a are attached to top and bottom bars 50b, 48b, respectively. In this Stage 1 position, the length of the bassinet is vertically oriented. Thus, the position of the first chamber 24a is elevated well above the support surface S. Further, the wall height of the side walls 28, 29, 30, 31 on the first chamber 24a is relatively short in the Stage 1 configuration. This places the first bottom panel 26 well above the support surface S as well. In the one disclosed example, the 8-10 inch wall height of the first chamber 24a would position the first bottom panel 26 about 8-10 inches below the top of the bassinet 20, i.e., the side 40b in this Stage 1 position.

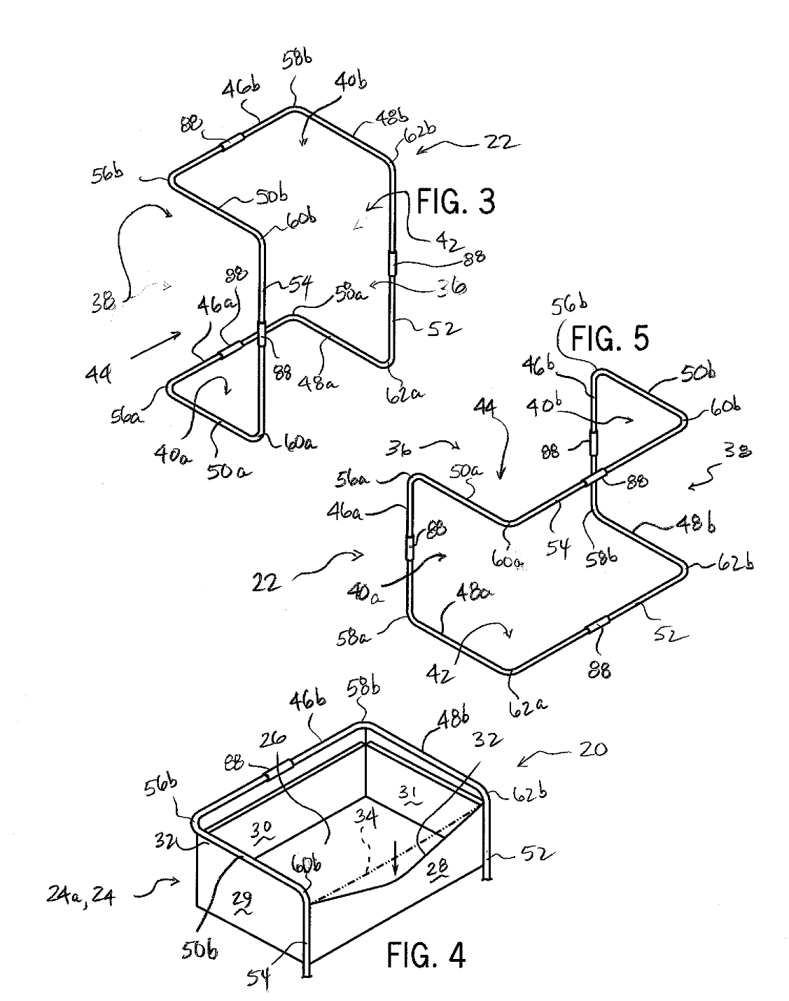

In accordance with the teachings of the present invention, the bassinet 20 can be repositioned to a Stage 2 position as depicted in FIGS. 5-7. A user need only rotate the frame 22 from the side 40a as in FIG. 3 onto the bottom 42 as in FIG. 5. In this example, the frame 22 need only be rotated about 90° when being repositioned from Stage 1 to Stage 2. The bassinet 20 can be repositioned also from Stage 2 to Stage 1 by rotating the frame back onto one of its sides, such as the side 40a. In the Stage 2 position, as shown in FIGS. 5-7, the frame 22 is positioned with the bottom 42 resting on the support surface S and with the sides 40a, 40b extending upward. In particular, the frame 22 rests on the bottom rail 52 and the bottom bars 48a, 48b in the Stage 2 position.

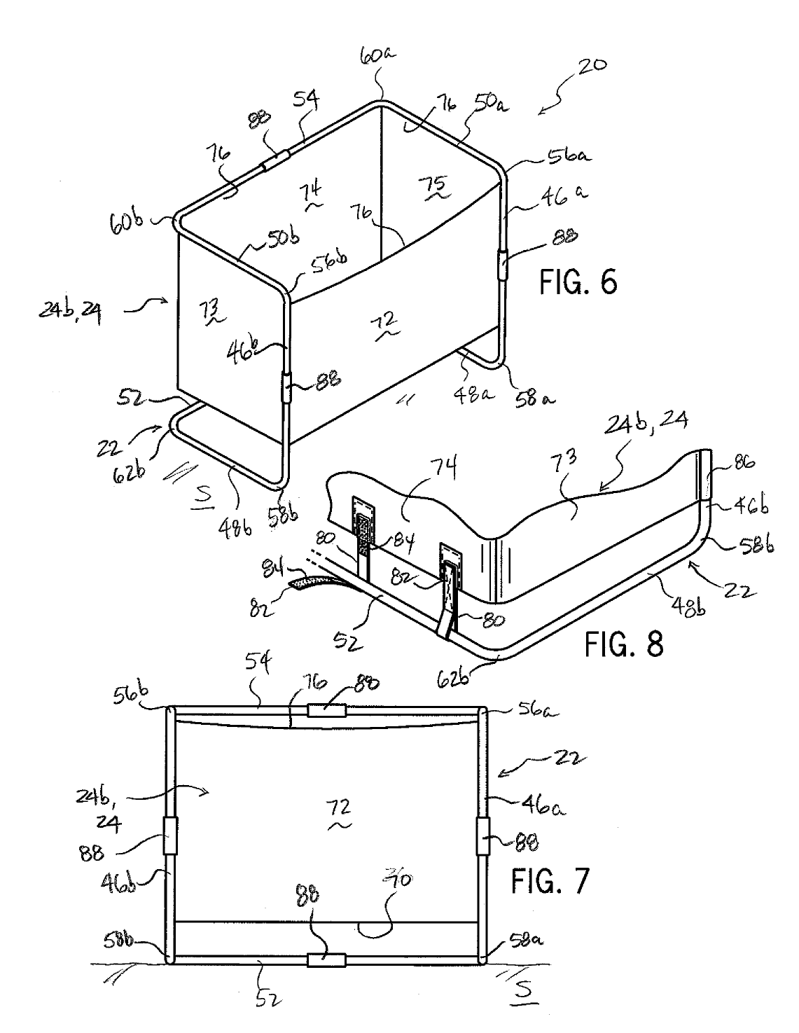

Also, the sleeping chamber 24 can be converted from the first chamber 24a to a second chamber 24b as depicted in FIGS. 6 and 7. In one example, the first chamber 24a can be removed from the frame 22 and replaced by an entirely different second chamber 24b, once the frame is repositioned. Alternatively, the first chamber 24a can remain attached to the frame and can be slidable, movable, repositionable, and/or reconfigurable from the first chamber 24a configuration to the second chamber 24b configuration. In another alternative, the sleeping chamber can be configured in the first chamber 24a configuration and attached to the frame in the Stage 1 position. The sleeping chamber 24 can be removed from the frame 22, reconfigured to the second chamber 24b configuration, and then reattached to the frame in the Stage 2 position.

In the Stage 2 position in this example, the second chamber 24b is attached to and suspended from the top 44 of the frame 22. As shown in FIG. 6, when the bassinet 20 is in the Stage 2 position, the sleeping chamber 24 is configured as the second chamber 24b for supporting a Stage 2 infant or child. In this example, the second chamber 24b has a second bottom panel 70 surrounded by perimeter side walls 72, 73, 74, 75. The side walls 72, 73, 74, 75 each extend to and terminate at a top edge 76, which defines an open top end of the chamber 24b. In this example, the side walls 72, 73, 74, 75 have a minimum first wall height that is suitable for a 3-6 month or older, Stage 2, infant, and in one example can be at least 20 inches in height. Also in this example, the top edges 76 of one or more of the walls 72, 73, 74, 75 can be attached to the frame 22, as described in greater detail below, which in turn suspends the second bottom panel 70 above the support surface S. For the Stage 2 position, the second bottom panel 70 is elevated above the support surface S at a second elevation that, in this example, is substantially lower than the first elevation for the first bottom panel 26 of the first chamber 24a. The second elevation can be such that the infant or child will be securely held within the taller chamber walls, even if the child rises up on their knees and elbows or rises to a sitting position.

FIGS. 6 and 7 show the second chamber 24b attached to the frame 22 with the frame and bassinet in the Stage 2 position. In this example, the second bottom panel 70 is also generally rectangular with four edges defining the perimeter. The second bottom panel 70 is surrounded by the four side walls 72, 73, 74, 75 that extend upward from the corresponding perimeter edges of the bottom panel. As will become evident to those of ordinary skill in the art, the shape and size of the second chamber 24b can also vary from the rectangular example shown and described with reference to FIGS. 6 and 7. Also, the side wall height can vary for each of the side walls, or each can be of the same height. In this example, the side wall 72 defines a front of the second chamber 24b and is shorter than the rear of the chamber defined by the side wall 74. Similarly, the ends of the chamber are defined by the side walls 73, 75, each being of a similar height to the rear side wall 74 in this example. One or more of the walls 72, 73, 74, 75, such as the front side wall 72 can also have an elastic cord or band (not shown) along its top edge 76, if desired.

Either or both of the first and second chambers 24a or 24b, i.e., the sleeping chambers 24, can be fabricated from any suitable material or material layers. The walls can be different from the bottom panels in material and construction. In one example, the chambers 24 can be made from sewn fabric materials or material layers. The chambers 24 can also include padding, decorative patterns and the like. Further, the chambers can be secured to the frame 22 in any suitable manner. FIG. 8 shows two examples and is provided only for illustrative purposes to represent optional, exemplary securing devices and methods. In one example, portions of the chambers 24 can include fabric straps 80 extending from edges and/or corners of the side walls, the bottom panels, or the like. The fabric straps can include a free end 82 that can wrap around the frame 22 and fasten to part of the chamber 24 or to a portion of itself. Fasteners can be employed as needed to secure the straps 80 and can include hook and loop type fasteners 84, such as VELCRO patches, or other suitable fasteners such as buttons, snaps, hooks or the like. Alternatively, edges, corner portions, or other surfaces of the sleeping chamber 24 can include sewn fabric tunnels 86 or loops therealong. The tunnels 86 can slip over the frame 22 to secure the chamber 24 to the frame. These devices can be permanently closed tunnels or loops, or can be openable to allow for direct removal from the frame 22. As will be evident to those having ordinary skill in the art, the attachment methods and devices used to secure the chambers 24 to the frame 22 can vary within the spirit and scope of the present invention.

In the example in FIGS. 1-8, the frame 22 components have a tubular structure. The frame can be provided in pieces that can be separated from and reattached to one another. The frame can be fabricated from any suitable material, such as steel, aluminum, plastic, composites, wood, or the like. In this example, the frame 22 tubes can be releasably fastened together at the various bends. In this example, connectors 88 can be provided along any one or more of the rails and bars to allow the frame 22 to be further broken down to smaller sub-components for compact packaging, shipping, storage, and the like. In one example, the joints and/or connectors 88 can be unfastened or disconnected to permit the soft goods of the sleeping chambers 24 to be removed, repositioned, and/or replaced to reconfigure the bassinet 20 between the Stage 1 and Stage 2 positions. In another example, the frame 22 can be a continuous tube and welded to create a permanently assembled frame structure. In other examples, the frame 22 may be constructed using any number of fastened pieces or components.

The Stage 1 bassinet 20 of FIG. 1 can be positioned with the elastic cord 34 nearest a caregiver's bed to provide ready access to a child while the caregiver is in bed. Alternatively, the bassinet 20 may be positioned with the band or cord 34 and the front wall of the sleeping chamber 24 overhanging the caregiver's bed to provide additional safety and peace of mind so that if the child escapes the sleeping chamber, the child will fall onto the bed.

As noted above, and with reference to FIGS. 1, 2, 6, and 7, the top edges 32 and 76 of the respective side walls 28-31 and 72-75, and the first and second bottom panels 26, 70 of the first and second chambers 24a and 24b are different in wall height and in vertical elevation. In this example, the side walls 28-31 of the first chamber 24a are significantly shorter than the side walls 72-75 of the second chamber 24b. In one example, the wall height of the first chamber can be 8-10 inches and the wall height of the second chamber can be 20 inches or greater. In addition, the first bottom panel 26 is spaced significantly farther above the support surface S in the Stage 1 position in comparison to the second bottom panel 70 in the Stage 2 position. The length of the bottom 42 (width of the frame) is also longer than the depth or height of the frame. Thus, with the frame on its side 40a in the Stage 1 position, the first chamber 24a and the first bottom panel 26 is further positioned at a higher elevation than that of the second chamber 24b as well as the second bottom panel 70 in the Stage 2 position during use.

The convertible bassinet 20 can be assembled or set up in a selected one of the Stage 1 or Stage 2 positions very easily. In this example, one may select the appropriate stage and position the frame 22 on the surface S accordingly. They can then either select the appropriate sleeping chamber 24a, 24b or reconfigure the sleeping chamber 24 to the appropriate chamber configuration. The user can connect, move, reposition, reorient, and/or rearrange the sleeping chamber 24 so that the chamber is secured or attached to the frame 22, such as by the devices represented in FIG. 8. In one example, fabric tunnels 86 can be slipped over portions of the frame 22 as needed and then the frame assembly can be completed. Fabric straps 82 can then be used to secure the bottom panels to the frame 22 as depicted in FIG. 8. At this point, the bassinet 20 is ready for use. In order to convert the bassinet to the other stage position, the assembly process is reversed to disassemble the bassinet. The frame 22 can then be repositioned. Then the appropriate sleeping chamber 24 can be fitted to the frame 22. Thus, in order to reconfigure the disclosed bassinet 20 from a Stage 1 sleeper for small infants and newborns, a user need only flip the frame 22 from its side onto its bottom and then rearrange the fabric sleeping chamber material to alter the side wall height.

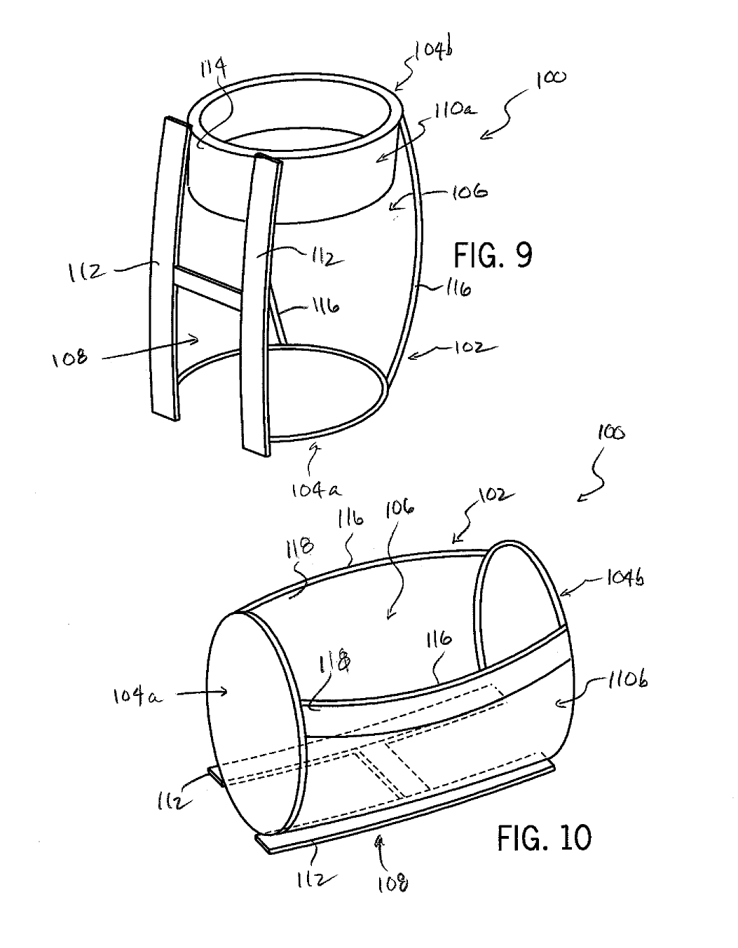

FIGS. 9 and 10 show another example of a convertible bassinet 100 constructed in accordance with the teachings of the present invention and in a Stage 1 and Stage 2 position, respectively. Similar to the earlier described examples, this example has a frame 102 with spaced apart sides 104a, 104b, a top 106, and a bottom or base 108. In this example, the frame 102 has a different structure that the frame 22, simply to illustrate one of many possible alternate frame configurations. The frame 102 is barrel shaped instead of rectangular. In addition, the bassinet 100 also utilizes a first chamber 110a for the Stage 1 position and a second chamber 110b for the Stage 2 position. Each of the chambers is non-rectangular in this example. The stage 1 chamber 110a is circular and the stage 2 chamber 110b is somewhat elliptical.

Also in this example, the frame 102 has a pair of curved bottom rails 112 that can act as rockers with the bassinet 100 in the Stage 2 position. The frame 102 can be configured to provide a rocking function in the Stage 1 position or both stages. Rockers can also be provided on bassinets of different construction including the bassinet 20 discussed above. In this example, the rockers 112 can be bowed wooden planks.

In the Stage 1 position shown in FIG. 9, the first chamber 110a is suspended by its top edge 114 by a circular frame element on the one end 104a of the frame 102. In this example, the frame is again longer than it tall or deep, resulting in the same Stage 1 and 2 position variations as discussed above. In the Stage 2 position sown in FIG. 10, the second chamber 110b is suspended from intermediate rails 116 extending between the sides 104a, 104b by its top edge 118. The chamber 110b has taller side walls and its bottom panel is positioned much closer to the surface 5, similar to the earlier described example.

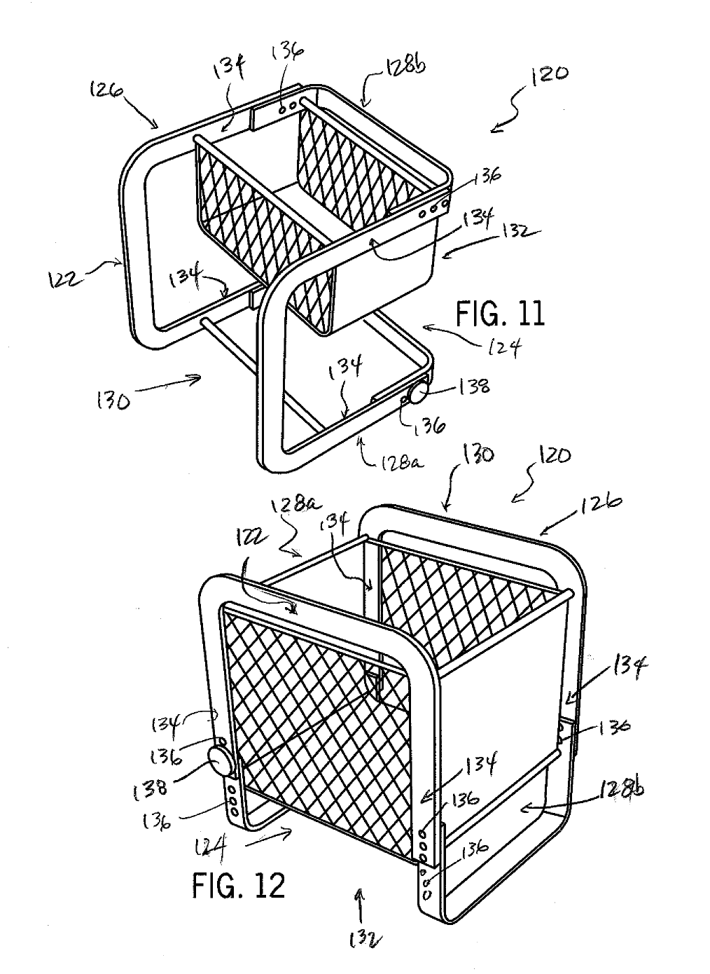

FIGS. 11 and 12 show another example of a convertible bassinet 120 constructed in accordance with the teachings of the present invention and in a Stage 1 and a Stage 2 position, respectively. This example is substantially similar to the example shown in FIGS. 1-8, but has a wood frame 122, again to show an alternate frame structure. In this example, the frame 122 has a front 124, a back 126, opposed sides 128a, 128b, a top 130, and a bottom 132 configured similarly to the frame 22 described previously. In the stage 1 position, the frame 122 rests on one of its sides 128a. In the Stage 2 position, the frame 122 rests on its bottom, which would equate to the front 36 or rear 38 of the frame 22 in the first example described herein. In this example, vertical legs 134 of the frame 122 are length adjustable, allowing a user to vary the height of the bassinet to accommodate their own needs. The bassinet can be configured so as to be height adjustable in the Stage 1 position, the Stage 2 position (as sown), or both, if desired.

In this example, each of the legs 134 is provided with a pair of leg segments slidably adjustable relative to one another, each having a series of through holes 136 and a locking mechanism 138. The locking mechanism 138 can be secured in a selected set of the holes 136 in each of the segments of the legs 134 to alter the frame height. The mechanism can include a knob 140 with a shank (not shown) that is removably insertable through the selected hole set.

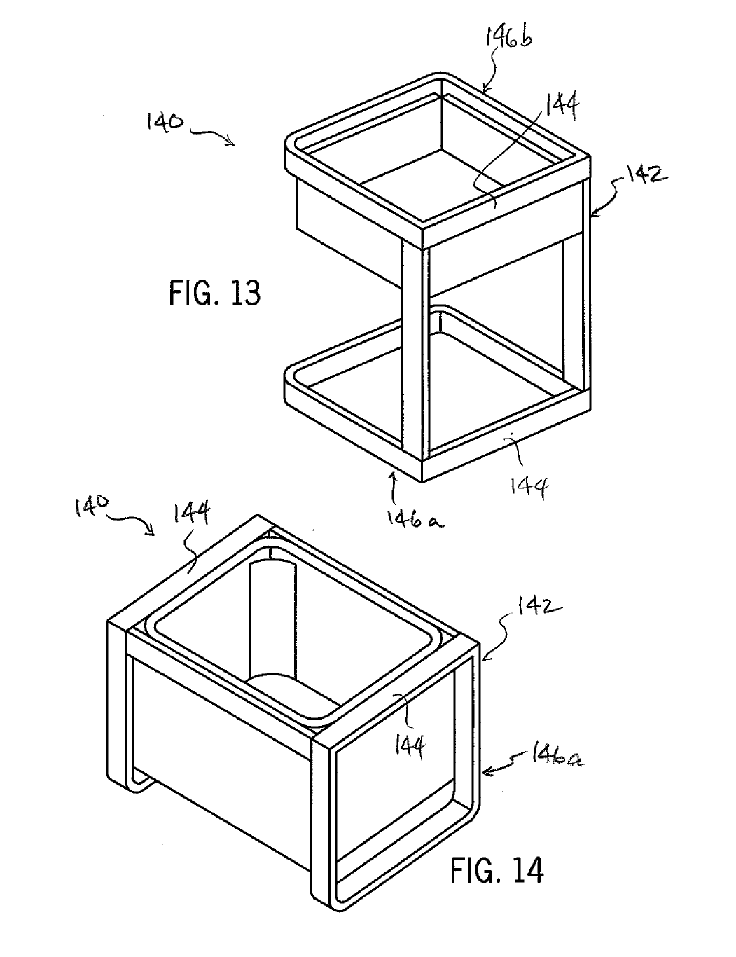

FIGS. 13 and 14 show yet another example of a convertible bassinet 140 constructed in accordance with the teachings of the present invention and in a Stage 1 and a Stage 2 position, respectively. This example has a frame 142 that is substantially similar in configuration to the examples shown in FIGS. 1-8 and FIGS. 11 and 12. However, the frame 142 has an additional cross bar 144 on each side 146a, 146b of the frame. Thus, each frame side 146a, 146b is a closed box shape instead of a three sided configuration. In the Stage 1 position, the frame 142 may be potentially more stable with a four-sided shape. The top and bottom can also be provided with a four sided structure to add further stability to the bassinet 140, if desired. In this example, the frame 140 components are depicted as being constructed from wood.

The disclosed bassinets may vary in assembly and composition as is shown in the variety of representative examples disclosed herein. Each example may have soft goods that provide comfort and any other desired features for comfortably supporting an occupant. The soft goods, including side walls, may include mesh as in FIGS. 11 and 12 or can include substantially transparent portions to allow the child and/or caregiver to see through the side walls.

In one aspect of the invention, in the Stage 1 (0-3 months) position, the bassinets can be oriented to dispose the child sleep surface in a raised position relative to a parent. Furthermore, in the Stage 1 position, the area of the sleep surface can be minimized or optimized to better contain a smaller child.

In another aspect of the invention, in the Stage 2 (3 plus months) position, the bassinets can be oriented or positioned so the area of the child sleep surface can be increased relative to that of the Stage 1 position so as to accommodate a larger child. In addition, the minimum wall height of the bassinet can be increased to 20 inches or more in the Stage 2 position and comply with existing safety standards. This can allow a longer period of use for the bassinets and can eliminate or delay the need to obtain a second sleeping product for a Stage 2 child.

In another aspect of the invention, a bassinet can be provided where the Stage 1 position has a papasson or hammock shape to provide comfort and security to a young infant. The hammock soft goods may also provide deep pressure touch to the sides of the child similar to the pressure touch the child feels in the womb, which is soothing to the child. The Stage 1 design can allow for flexibility of the soft goods so that a caregiver can select the bassinet to be set up like the hammock or to have a more rigid flat surface similar to a traditional bassinet.

Other aspects of the disclosure can include providing a cantilever frame style for Stage 1 suspending the child sleeping area or chamber. The cantilever frame style may have some spring tension or resiliency to allow for reactive motion when the child moves or when the caregiver interacts with the child or bassinet. This reactive motion can stimulate the child's proprioceptive system and can soothe the child.

In still another aspect of the disclosure, the frame for Stage 1 may have a C or U-shaped profile (see FIGS. 1 and 3 for example). This shape allows the child sleeping area of the bassinet to overhang the caregivers' bed. The Stage 2 position of the bassinet may include rocker rails so the bassinet rocks when the caregiver pushes it. The rocking creates rhythmic motion, which can stimulate the child's vestibular system and help to sooth the child. In one example, the rocking feature may include a feature so as to be muted or locked out so the bassinet is more stationary, if desired. The soft goods may be designed so that the soft goods for Stage 1 are connected to the soft goods for Stage 2. The Stage 1 and Stage 2 soft goods may also be designed to fit on a frame simultaneously, regardless of the position of the bassinet being used. One benefit of the soft goods is to provide a design that can be used for both age groups to avoid losing one set when not in use. Alternatively, the soft goods may be made separately with a slot on the frame or other soft goods to pack it when not in use to prevent misplacement. If connected, the soft goods can include zipper sections that can be paid out or taken in, depending on the sleeping chamber stage desired.

The soft goods may have rigid panels (as in, for example, the panels of a GRACO Travel Bed product) to give a sense of comfort and stability. In one example, the rigid structure soft goods may be collapsible for both Stage 1 and 2 positions. This can be beneficial for packaging and travel. In some examples, the Stage 1 soft goods may be removable and usable as a stand alone travel bed. The mattress could also be used for both age orientations (folded in half for Stage 1 and opened for Stage 2). Due to the specified fold strategy, the corner walls can be used to anchor the mattress and add more shape options.

Although certain convertible bassinet examples have been described herein in accordance with the teachings of the present disclosure, the scope of coverage of this patent is not limited thereto. On the contrary, this disclosure covers all embodiments of the teachings of the disclosure that fairly fall within the scope of permissible equivalents.

What is claimed is:

1. A convertible bassinet comprising:
a frame having a bottom and spaced apart sides extending from the bottom;
a first chamber attachable to the frame and having a first bottom panel and a first plurality of walls extending up from a perimeter of the first bottom panel and having a first minimum wall height; and
a second chamber attachable to the frame and having a second bottom panel and a second plurality of walls extending up from a perimeter of the second bottom panel and having a second minimum wall height,
wherein the frame can be arranged in a first position resting on one of the sides and supporting the first chamber and in a second position resting on the bottom and supporting the second chamber, and
wherein the second minimum wall height is greater than the first minimum wall height.

2. A convertible bassinet according to claim 1, wherein the frame is a continuous tube having multiple bends.

3. A convertible bassinet according to claim 1, wherein the sides of the frame are extendible to increase a height of the frame in the second position.

4. A convertible bassinet according to claim 1, wherein the first and second chambers are formed in part by one another.

5. A convertible bassinet according to claim 1, wherein when one of the first or second chambers is attached to the frame, the other of the first and second chambers can be stowed.

6. A convertible bassinet according to claim 1, wherein the bottom of the frame has a length between the sides and the bottom is curved along the length.

7. A convertible bassinet according to claim 6, wherein the curved bottom includes two spaced apart rocker rails along the length on which the frame rests in the second position.

8. A convertible bassinet according to claim 1, wherein the first chamber is cantilevered on the frame in the first position.

9. A convertible bassinet according to claim 1, wherein the frame includes two spaced apart bottom bars extending horizontally along the bottom and between the sides.

10. A convertible bassinet according to claim 9, wherein each side includes two spaced apart side bars connected at an end to a corresponding end of one of the bottom bars, and wherein the spaced apart side bars are interconnected on each side by a cross bar.

11. A convertible bassinet according to claim 1, wherein the bottom has a first orientation with the frame in the first position and a second orientation with the frame in the second position, the first and second orientations being generally perpendicular relative to one another.

12. A convertible bassinet according to claim 1, wherein the frame is reoriented about 90° when repositioned between the first and second positions.

13. A convertible bassinet configured to rest on a support surface, the convertible bassinet comprising:
a frame having a bottom and spaced apart sides extending up from the bottom;
a first chamber attachable to the frame and having a first bottom panel; and
a second chamber attachable to the frame and having a second bottom panel,
wherein the frame can be arranged in a first position resting on one of the sides and supporting the first chamber with the first bottom panel at a first elevation above the support surface and in a second position resting on the bottom and supporting the second chamber with the second bottom panel at a second elevation above the support surface, and
wherein the first elevation is greater than the second elevation.

14. A convertible bassinet according to claim 13, wherein the first chamber has a first plurality of walls extending up from a perimeter of the first bottom panel and having a first minimum wall height; and wherein the second chamber has a second bottom panel and a second plurality of walls extending up from a perimeter of the second bottom panel and having a second minimum wall height, the second minimum wall height being greater than the first minimum wall height.

15. A convertible bassinet according to claim 13, wherein the first chamber and the second chamber are formed at least in part by a common section of a fabric material.

16. A convertible bassinet according to claim 13, wherein the frame is reoriented about 90° when repositioned between the first and second positions.

17. A convertible bassinet according to claim 13, wherein the first and second chambers are removably secured to the frame at least in part by a plurality of fabric straps.

18. A convertible bassinet according to claim 13, wherein the frame is a continuous, bent, structure when in either of the first and second positions.

19. A convertible bassinet according to claim 13, wherein a portion of the frame is extendable and retractable to alter a height of the frame in at least one of the first and second positions.

20. A method of reconfiguring a bassinet from a first sleeping configuration to a second sleeping configuration, the method comprising the steps of:
providing a frame having a bottom and spaced apart sides extending up from the bottom;
positioning the frame in a first position with one of the sides resting on a support surface;
securing a first chamber having a first bottom panel to the frame such that the first bottom panel is suspended above the support surface;
repositioning the frame to a second position with the bottom resting on the support surface; and
securing a second chamber having a second bottom panel to the frame such that the second bottom panel is suspended above the support surface.
